(19) United States
(12) Patent Application Publication
(10) Pub. No.: US 2025/0053354 A1
(43) Pub. Date: Feb. 13, 2025

(54) INFORMATION PROCESSING APPARATUS AND INFORMATION PROCESSING METHOD

(71) Applicant: Toshiba Tec Kabushiki Kaisha, Tokyo (JP)

(72) Inventors: Yusuke HAMADA, Mishima Shizuoka (JP); Sou MIYAZAKI, Sunto Shizuoka (JP); Kouichirou NISHI, Sunto Shizuoka (JP); Yutaka KUKITSU, Sunto Shizuoka (JP)

(21) Appl. No.: 18/629,744

(22) Filed: Apr. 8, 2024

(30) Foreign Application Priority Data
Aug. 10, 2023 (JP) 2023-131569

(51) Int. Cl. G06F 3/12

(52) U.S. Cl. CPC G06F 3/1226; G06F 3/1204; G06F 3/1285

(57) ABSTRACT

In accordance with an embodiment, an information processing apparatus receives printing media type information indicating a type of printing media on which images are to be printed. The information processing apparatus causes a display device to display printer information indicating each of one or more printers satisfying a condition related to the type on the basis of the received printing media type information.

### CROSS-REFERENCE TO RELATED APPLICATION

This application is based upon and claims the benefit of priority from the prior Japanese Patent Application No. 2023-131569, filed on Aug. 10, 2023, the entire contents of which are incorporated herein by reference.

### FIELD

An embodiment described here generally relates to an information processing apparatus and an information processing method.

### BACKGROUND

Conventionally, an information processing apparatus that is capable of searching for a multifunction peripheral of multifunction peripherals located near a current location of a user, which is capable of printing an image wished by the user to print, is known.

The conventional information processing apparatus is capable of collecting information indicating available sheets, printing costs, whether or not a malfunction has occurred, and the like in each of a plurality of multifunction peripherals connected to a network and providing the user with them. However, with the information processing apparatus, the user should have judged which multifunction peripheral is a multifunction peripheral suitable to printing the image on the basis of information provided from the information processing apparatus by him- or herself.

### BRIEF DESCRIPTION OF THE DRAWINGS

FIG. 1 is a diagram showing an example of a configuration of an information processing system according to an embodiment.

FIG. 2 is a diagram showing an example of a type of printing media set to each sheet feeding cassette of a printer.

FIG. 3 is a diagram showing an example of a target printer list display image according to the embodiment.

FIG. 4 is a diagram showing an example of a map displayed by a first information processing apparatus in a case where the first information processing apparatus has received an operation via the target printer list display image shown in FIG. 3.

FIG. 5 is a block diagram showing an example of an information processing apparatus according to the embodiment.

FIG. 6 is a diagram showing an example of processing in which the first information processing apparatus according to the embodiment displays the target printer list display image.

FIG. 7 is a diagram showing an example of processing in which a server 10 that has acquired search information according to the embodiment outputs registration information.

### DETAILED DESCRIPTION

In accordance with an embodiment, an information processing apparatus is capable of selecting a printer suitable to printing an image from a plurality of printers connected to a network. The information processing apparatus includes an input device, a display device, and a processor. The input device inputs printing media type information indicating a type of printing media on which images are to be printed. The display device displays printer information indicating a printer. The processor generates search information at least including the printing media type information input by the input device. The processor acquires, on the basis of registration information including the printer information indicating each of the plurality of printers prestored and the generated search information, registration information including printer information indicating each of one or more printers satisfying a condition related to the type of printing media. In addition, the processor causes the display device to display printer information included in the acquired registration information.

An information processing system according to an embodiment will be described with reference to the drawings. In each figure, the same configurations will be denoted by the same reference signs. As an example of the information processing system according to the embodiment will be described taking an information processing system 1 as an example.

### Configuration of Information Processing System

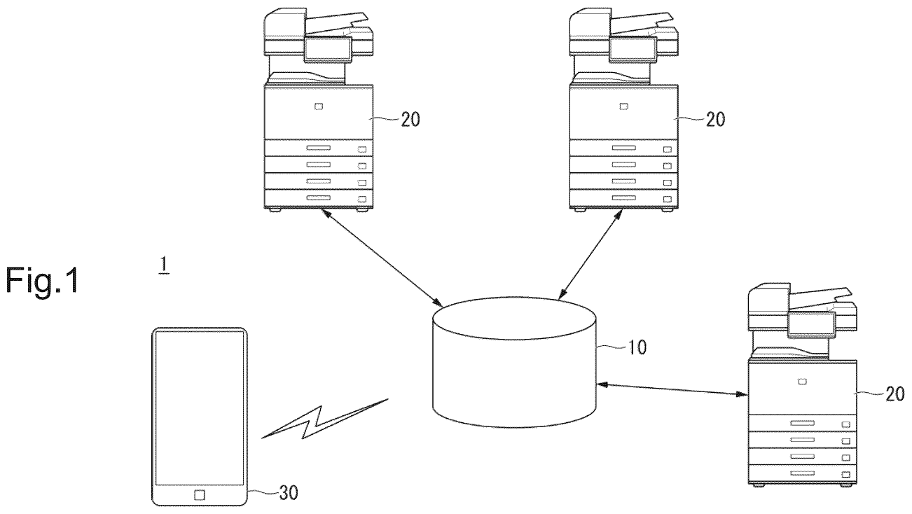

A configuration of the information processing system 1 will be described with reference to FIG. 1. FIG. 1 is a diagram showing an example of the configuration of the information processing system 1.

The information processing system 1 causes the user to search for a printer suitable to printing an image desired by the user.

The information processing system 1 includes, for example, a server 10, an N-number of printers 20, and an M-number of information processing apparatuses 30. N may be any integer as long as it is one or more integers. M may be any integer as long as it is one or more integers. For the sake of description, the N-number of printers 20 are denoted by the same reference sign. However, some or all of the N-number of printers 20 may be different types of printers. In FIG. 1, for the sake of simplification, three printers 20 are shown as an example of the N-number of printers 20. For the sake of description, the M-number of information processing apparatuses 30 are denoted by the same reference sign. However, some or all of the M-number of information processing apparatuses 30 may be different types of information processing apparatuses. In FIG. 1, for the sake of simplification, a single printer 20 is shown as an example of the M-number of information processing apparatuses 30.

In the information processing system 1, the server 10 is connected to be capable of communicating with each of the N-number of printers 20 wirelessly or with a wire. In the example shown in FIG. 1, the server 10 is connected to be capable of communicating with each of the three printers 20 with a wire. The server 10 may communicate with some or all of the N-number of printers 20 via different communication networks or may communicate with some or all of the N-number of printers 20 via different communication networks via the same communication network.

In the information processing system 1, the server 10 is connected to be capable of communicating with each of the M-number of information processing apparatuses 30 wirelessly or with a wire. In the example shown in FIG. 1, the server 10 is connected to be capable of communicating with a single information processing apparatus 30 wirelessly. The server 10 may communicate with some or all of the M-number of information processing apparatuses 30 via different communication networks or may communicate with some or all of the M-number of information processing apparatuses 30 via the same communication network.

As an example, a case where the N-number of printers 20 have logged in the server 10 will be described. That is, in the present embodiment, descriptions of processing and the like associated with the N-number of printers 20 logging in the server 10 will be omitted. As an example, a case where the M-number of information processing apparatuses 30 have logged in the server 10 will be described. That is, in the present embodiment, descriptions of processing and the like associated with the M-number of information processing apparatuses 30 logging in the server 10 will be omitted.

The server 10 receives an operation from each of the M-number of information processing apparatuses 30. For the sake of description, the information processing apparatus 30 shown in FIG. 1 will be described, referred to as a first information processing apparatus. The processing performed by the server 10 in accordance with an operation received from the first information processing apparatus is processing similar to the processing performed by the server 10 in accordance with an operation received from the information processing apparatus 30 other than the first information processing apparatus. As an example, taking the processing performed by the server 10 in a case where the server 10 has received an operation from the first information processing apparatus as an example, a configuration of the server 10 will be described.

The server 10 has prestored registration information about each of the N-number of printers 20.

Registration information regarding a certain printer 20 is information in which printer identification information, first printable printing media type information, second printable printing media type information, printer location information, contact information, and the like regarding the printer 20 are associated with each other.

The printer identification information regarding the certain printer 20 is information identifying the printer 20. The printer identification information may be any information as long as the information can identify the printer.

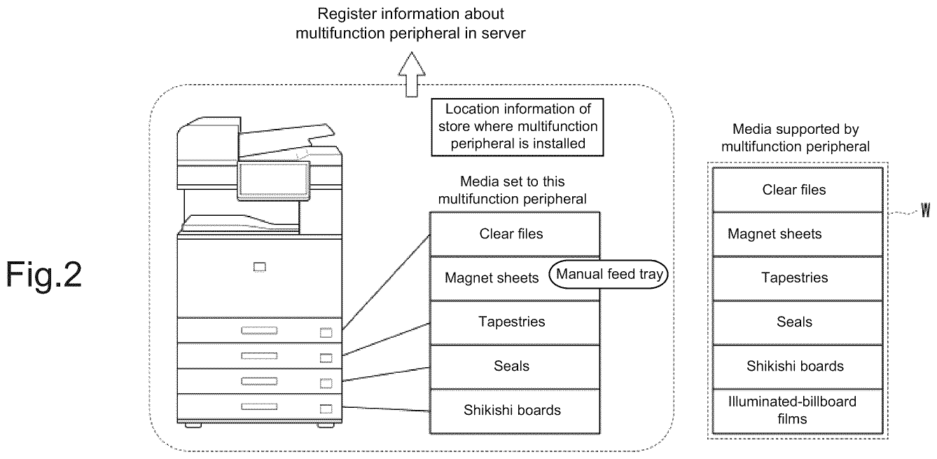

The first printable printing media type information regarding the certain printer 20 is information indicating a type of printing media set to each of one or more sheet feeding cassettes of the printer 20. FIG. 2 is a diagram showing an example of the type of printing media set to each sheet feeding cassette of the certain printer 20. The printer 20 shown in FIG. 2 includes four sheet feeding cassettes. Clear files are set as printing media in the uppermost sheet feeding cassette of the four sheet feeding cassettes. Tapestries are set as printing media in the second uppermost sheet feeding cassette of the four sheet feeding cassettes. Seals are set as printing media in the third uppermost sheet feeding cassette of the four sheet feeding cassettes. Shikishi boards (special type of square card paper) are set as printing media in the lowermost sheet feeding cassette of the four sheet feeding cassettes. The clear files, the tapestries, the seals, and the shikishi boards are examples of the type of printing media. Magnet sheets are further set to a manual feed tray of the printer 20. The information processing system 1 may have a configuration in which the type of printing media set to the manual feed tray is handled as the type of printing media set to each of one or more sheet feeding cassettes of the printer 20. The information processing system 1 may have a configuration in which the type of printing media set to the manual feed tray is not handled as the type of printing media set to each of one or more sheet feeding cassettes of the printer 20. For the sake of description, the printing media set to each sheet feeding cassette provided in the certain printer 20 will be described, referred to as printing media set to the printer 20.

The second printable printing media type information regarding the certain printer 20 is information indicating the type of printing media provided to customers as printing media that can be printed by the printer 20 in a facility where the printer 20 is placed. The facility includes a store where the printer 20 is placed, a station where the printer 20 is placed, a university where the printer 20 is placed, a library where the printer 20 is placed, for example, though not limited thereto. In FIG. 2, second printable printing I media type information indicating a type of printing media provided to customers as printing media that can be printed by the printer 20 in the facility where the printer 20 shown in FIG. 2 is placed is shown within a frame W. Clear files, magnet sheets, tapestries, seals, shikishi boards, and illuminated-billboard films are provided to customers as the type of printing media that can be printed by the printer 20 in the facility.

A difference between the first printable printing media type information and the second printable printing media type information regarding the certain printer 20 indicates a certain type of printing media. The type of printing media is a type of printing media stored in the facility as printing media which have not been set to the printer 20 and which can be set to the printer 20 in the facility where the printer 20 is placed. A difference between the first printable printing media type information and the second printable printing media type information regarding the printer 20 shown in FIG. 2 is the illuminated-billboard films. That is, the illuminated-billboard films are an example of the type of printing media stored in the facility as printing media which have not been set to the printer 20 and which can be set to the printer 20 in the facility where the printer 20 is installed.

The printer location information regarding the certain printer 20 is information indicating a location of the printer 20. The printer location information may information indicating a location of the printer 20 or may be information indicating a location of the facility where the printer 20 is placed.

The contact information regarding the certain printer 20 is information indicating a contact for bidirectionally communicating with an information processing apparatus in the facility where the printer 20 is placed through a message, a voice call, or the like. For example, in a case where the information processing apparatus is a smartphone, the contact information includes mail addresses, an account for sending/receiving a short message, an account of a Social Networking Service (SNS), and telephone numbers, for example, though not limited thereto.

Such registration information is registered in the server 10 via each printer 20. In other words, when the server 10 acquires the registration information output from each printer 20, the server 10 stores the acquired registration information.

When the server 10 acquires search information from the first information processing apparatus, the server 10 performs processing according to the acquired search information. The search information is information including printing media type information indicating a type desired by a user of the first information processing apparatus as a type of printing media on which images are to be printed. The printing media type information may be information indicating one type or may be information indicating two or more types. The search information may be any information as long as the information includes the printing media type information. As an example, a case where the search information includes printing media type information, current location information, and search area information will be described. The current location information is information indicating the current location H the first information processing apparatus. The search area information is information indicating a radius of a circular area having the current location indicated by the current location information as a center. For the sake of description, the type desired by the user of the first information processing apparatus as the type of printing media which is the image printing target will be described, referred to as a target type.

When the server 10 acquires search information, the server 10 selects each of the one or more printers 20 satisfying a selection condition related to the target type as a target printer on the basis of printing media type information included in the acquired search information and prestored registration information. The selection condition is, for example, a condition including two conditions, the following conditions 1 and 2.

Condition 1: printing media of the target type has been set to the printer 20. Condition 2: the printing media of the target type have been stored as printing media which can be set to the printer 20.

In a case where the printing media type information indicates one target type, the server 10 determines that the selection condition has been satisfied when at least one of the above-mentioned conditions 1 and 2 have been satisfied. In a case where the printing media type information indicates two or more target types, the server 10 determines that the selection condition has been satisfied when the conditions 1 and 2 are both satisfied as follows. That is, the server 10 determines that the selection condition has been satisfied when the condition 1 has been satisfied by a part of the printing media of each of the two or more target types and the condition 2 has been satisfied by another part of the printing media of each of the two or more target types. Each of one or more target printers selected under such a selection condition is the printer 20 installed in the facility, which allows printing using printing media of the type desired by the user of the first information processing apparatus. Accordingly, the server 10 is capable of selecting each of the one or more printers 20 suitable to image printing desired by the user of the first information processing apparatus, as a target printer.

The server 10 extracts a target printer of the one or more target printers selected, which is located in the periphery of the first information processing apparatus. The target printer located in the periphery of the first information processing apparatus is a target printer located within a search area having the first information processing apparatus as a center. The search area is a circular area. The location at the center of the search area is a current location indicated by the current location information included in the search information received by the server 10. The radius of the search area is a radius indicated by the search area information included in the search information received by the server 10. In a case where the number of target printers extracted is zero, the server 10 outputs information indicating that the target printer is located within the search area to the first information processing apparatus as the registration information. The information is, for example, null information, though not limited thereto. On the other hand, in a case where the number of target printers extracted is one or more, the server 10 outputs registration information of each of the one or more target printers extracted to the first information processing apparatus as a response to the acquired search information. Accordingly, the server 10 is capable of outputting to the first information processing apparatus the registration information regarding the printer 20 suitable to the image printing desired by the user of the first information processing apparatus.

The printer 20 is, for example, a multifunction peripheral, though not limited thereto. The printer 20 generates the above-mentioned registration information in accordance with the received operation and outputs the generated registration information to the server 10. The processing in which the printer 20 generates registration information may be any processing.

The information processing apparatus 30 is, for example, a multi-functional portable phone terminal (smartphone). Alternatively, the information processing apparatus 30 may be another information processing apparatus such as a tablet PC, a laptop personal computer (PC), a personal digital assistant (PDA), or a desktop PC. As an example, taking the processing in which the first information processing apparatus performs as an example, a configuration of the information processing apparatus 30 will be described.

The first information processing apparatus causes an information reception image to be displayed in accordance with, for example, a received operation. The information reception image is an image for receiving the printing media type information and the search area information. The information reception image may be any image as long as the image allows reception of the printing media type information and the search area information. When the first information processing apparatus receives the printing media type information and the search area information via the information reception image, the first information processing apparatus determines the current location of the first information processing apparatus. The first information processing apparatus generates information including current location information indicating the determined current location and printing media type information and search area information received via the information reception image. The first information processing apparatus outputs to the server 10 the generated search information. The first information processing apparatus acquires registration information regarding each of one or more target printing media as a response from the server 10 to the search information output to the server 10. Based on the one or more pieces of registration information acquired, the first information processing apparatus generates a target printer list display image that displays information regarding each of the one or more target printers. More specifically, the target printer list display image is an image that causes a list of printer information indicating the one or more target printers to be displayed. Printer information indicating a certain target printer may be any information as long as the information includes the printer location information regarding this target printer. For example, the printer information indicating the certain target printer is information including printer location information regarding this target printer, distance information, first printable printing media type information, and available printing media type information, for example. The distance information regarding this target printer is information indicating a distance between the current location of the first information processing apparatus and the location of the target printer. The distance may be a straight line distance or may be a distance along a movable path. The available printing media type information regarding the target printer is information indicating a difference between the first printable printing media type information and the second printable printing media type information regarding this target printer.

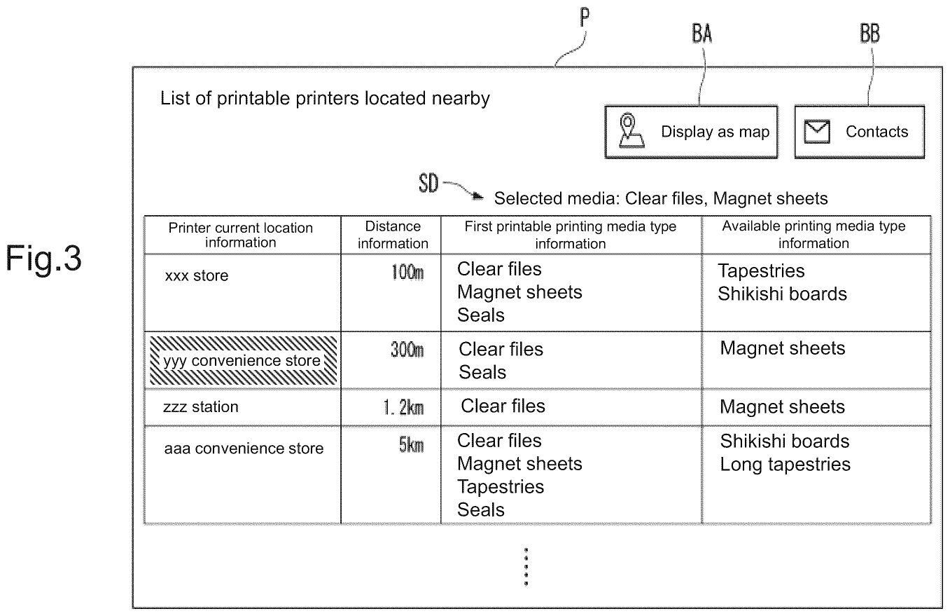

FIG. 3 is a diagram showing an example of the target printer list display image. An image P shown in FIG. 3 is an example of the target printer list display image. In the example shown in FIG. 3, information SD indicating the target type indicated by the printing media type information is displayed in the image P. In this example, the information SD indicates two target types, i.e., clear files and magnet sheets, as the target type indicated by the printing media type information. In this example, a list of printer information indicating four target printers is displayed in the image P. In the image P shown in FIG. 3, the target printer located at, for example, “xxx store” is a printer 20 satisfying the above-mentioned condition 1 and a distance from the current location of the first information processing apparatus is 100 m. The type of printing media set to this target printer includes three types, i.e., clear files, magnet sheets, and seals. In the facility where the target printer is placed, a type of printing media as printing media stored in the facility which have not been set to the target printer and which can be set to the target printer includes two types, i.e., tapestries and shikishi boards. In the image P shown in FIG. 3, for example, a target printer located at “zzz station” is a printer 20 satisfying both the above-mentioned condition 1 and the condition 2 and a distance from the current location of the first information processing apparatus is 1.2 km. The type of printing media set to this target printer is only one type, i.e., clear files. In the facility where the target printer is placed, a type of printing media as printing media stored in the facility which have not been set to the target printer and which can be set to the target printer is only one type, i.e., magnet sheets. The user of the first information processing apparatus is capable of easily determining a printer 20 suitable to image printing desired by the user by causing the first information processing apparatus to display such a target printer list display image. That is, the first information processing apparatus is capable of causing the user to search for the printer 20 suitable to image printing desired by the user.

In addition, the image P may be an image for receiving an operation of selecting printer information of the displayed printer information, which indicates the target printer desired by the user. In FIG. 3, printer information selected by this operation is shown by hatching. Specifically, in FIG. 3, a printer information indicating a target printer located at “yyy convenience store” is printer information selected by the user of the first information processing apparatus. In other words, a target printer located at “yyy convenience store” is an example of the target printer desired by the user.

In the example shown in FIG. 3, the image P includes a button BA and a button BB as graphical user interfaces (GUIs) operable by the user.

The button BA is a button for receiving an operation of causing the first information processing apparatus to display a map indicating the location of the target printer indicated by each of the one or more printers information displayed in the image P. This map is a type of image displayed by the first information processing apparatus and is a map within a search area including the current location of the first information processing apparatus. In the example shown in FIG. 3, when the first information processing apparatus receives this operation via the button BA, the first information processing apparatus causes a map indicating the location of the target printer indicated by each of four pieces of printer information displayed in the image P to be displayed.

The button BB is a button for receiving an operation of making a certain inquiry to a facility where a target printer of the target printers indicated by each of the one or more printers information displayed in the image P, which has been selected by the user, is placed. This inquiry is an inquiry as to whether or not the stored type of printing media in the facility are currently available. When the first information processing apparatus receives this operation via the button BB, for example, the first information processing apparatus determines registration information regarding this target printer. After the first information processing apparatus determines this registration information, the first information processing apparatus sends a predetermined message to this information processing apparatus in this facility by using a contact indicated by the contact information included in the determined registration information. This message is a message for making an inquiry as to whether or not the stored type of printing media in the facility are currently available and is, for example, “Are the stored type of printing media currently available?,” though not limited thereto. Sending such a message may be performed by a dedicated application program in accordance with the contact, may be performed through an e-mail, a short message, a social networking service (SNS), or the like, or may be performed by another method. The first information processing apparatus may be configured to cause the user to make such an inquiry, for example, through a voice call instead of sending such a message. The first information processing apparatus may be configured to send a predetermined voice instead of sending such a message. A situation where the stored type of printing media are unavailable is, for example, a situation where the inventory of the stored type of printing media is zero. The situation where the stored type of printing media are unavailable is, for example, a situation where the employee cannot set the stored printing media to the target printer because of a busy time. Alternatively, the situation where the stored type of printing media are unavailable may be another situation where the stored type of printing media are unavailable.

The first information processing apparatus may be configured to receive a response from the facility with respect to the above-mentioned inquiry through an e-mail, a short message, an SNS, or the like or may be configured to receive a response from the facility with respect to the above-mentioned inquiry through a voice call. This response is, for example, the messages “We are afraid to inform you that the inventory is currently unavailable,” “You can use printing media of your desired type,” or “We are afraid to inform you that we cannot address your request because it is busy time,” though not limited thereto.

In a case where contact information included in certain registration information is null information, the first information processing apparatus determines that the facility where the printer 20 is placed as to the registration information is a facility to which no inquiry can be made. That is, inquiries as described above cannot be made to all facilities. Therefore, the contact information included in the registration information may be null information.

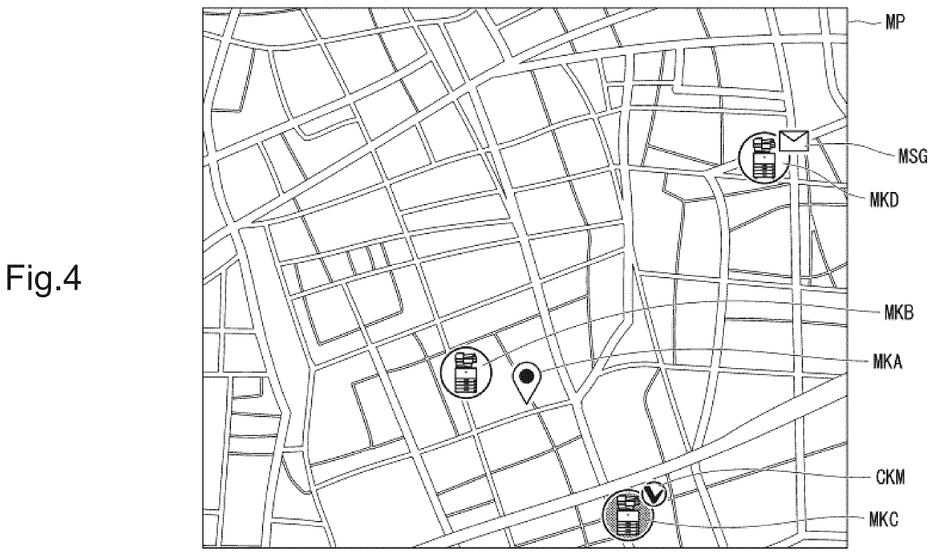

FIG. 4 is a diagram showing an example of a map displayed by the first information processing apparatus in a case where the first information processing apparatus has received an operation via the button BA shown in FIG. 3. A map MP shown in FIG. 4 is an example of a map displayed by the first information processing apparatus in this case. An image MKA indicating the current location of the first information processing apparatus is superimposed on the map MP. An image MKB indicating a location of a target printer of the target printers indicated by each of the four pieces of printer information displayed in the image P (FIG. 3), which is the closest to the first information processing apparatus, is superimposed on the map MP. An image MKC indicating a location of a target printer of the target printers indicated by each of the four pieces of printer information displayed in the image P, which is the second closest to the first information processing apparatus, is superimposed on the map MP. An image MKD indicating a location of a target printer of the target printers indicated by each of the four pieces of printer information displayed in the image P, which is the third closest to the first information processing apparatus, is superimposed on the map MP. An image MKE indicating a location of a target printer of the target printers indicated by each of the four pieces of printer information displayed in the image P, which is the furthest from the first information processing apparatus, is not shown in the map MP. The user of the first information processing apparatus is capable of displaying the image MKE on a display device 35 by scrolling the map MP or zooming out.

An image CKM indicating a target printer of the target printers indicated by each of the four pieces of printer information displayed in the image P (FIG. 3), which has been selected by the user of the first information processing apparatus, is superimposed on the image MKC in the map MP shown in FIG. 4. For example, in a case where the user has selected certain printer information in the image P, the first information processing apparatus superimposes the image indicating the target printer selected by the user on the image indicating the location of the target printer indicated by the selected printer information. On the other hand, for example, in a case where the user has selected no printer information in the image P, the first information processing apparatus does not superimpose the image indicating the target printer selected by the user on the image indicating the location of the target printer.

In the image MKD in the map MP, an image MSG indicating a target printing medium is superimposed at the location of the facility to which an inquiry as to whether or not the stored type of printing media is available can be made by an operation via the button BB. For example, in a case where contact information regarding printer indicated by certain printer information in the image P (FIG. 3) is null information, the first information processing apparatus superimposes the image indicating the target printing medium at the location of the facility in the image indicating the location of the target printer. On the other hand, for example, in a case where the contact information is null information, the first information processing apparatus superimposes no image indicating the target printing medium at the location of the facility in the image indicating the location of the target printer.

The first information processing apparatus may be configured to cause the display device of the first information processing apparatus to display the target printer list display image as in the image P (FIG. 3) or may cause a display device of another apparatus connected to be capable of communicating with the first information processing apparatus to be displayed. Accordingly, the first information processing apparatus is capable of causing the user to search for a printer suitable to the image printing desired by the user of the first information processing apparatus. The first information processing apparatus may be configured to acquire a target printer list display image from the server 10. In this case, the server 10 generates a target printer list display image on the basis of the search information acquired from the first information processing apparatus. Then, the server 10 outputs the generated target printer list display image to the first information processing apparatus as a response to the acquired search information.

### Functional Configuration of Information Processing Apparatus

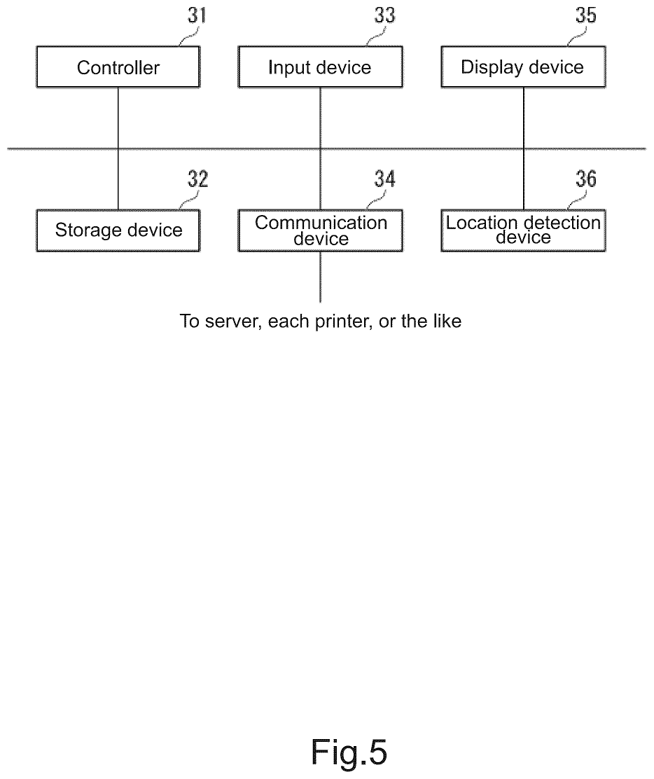

A functional configuration of the information processing apparatus 30 will be described with reference to FIG. 5. FIG. 5 is a block diagram showing an example of the information processing apparatus 30.

The information processing apparatus 30 includes, for example, a controller 31, a storage device 32, an input device 33, a communication device 34, and the display device 35. These components are connected to be capable of communicating with each other via a bus. Moreover, the information processing apparatus 30 communicates with the server 10 and the like via the communication device 34.

The controller 31 comprehensively controls the information processing apparatus 30. The controller 31 includes, for example, processors such as a central processing unit (CPU) and a field programmable gate array (FPGA). The controller 31 executes various programs stored in the storage device 32 and realizes various functions of the information processing apparatus 30. The controller 31 outputs the search information to the server 10, for example, via the communication device 34. The controller 31 acquires the registration information from the server 10, for example, via the communication device 34.

The storage device 32 includes, for example, a solid state drive (SSD), a hard disk drive (HDD), an electrically erasable programmable read only memory (EEPROM), a read only memory (ROM), and a random access memory (RAM). The storage device 32 may be an externally attachable storage device connected, for example, via a digital input/output port such as a universal serial bus (USB) instead of one built in the information processing apparatus 30. The storage device 32 stores various types of information, various programs, various images, and the like processed by the information processing apparatus 30.

The input device 33 includes a touch pad, a keyboard, a mouse, and the like. The input device 33 may be a touch panel configured to be integral with the display device 35. The input device 33 includes, for example, the buttons BA and BB as its parts.

The communication device 34 includes, for example, a digital input/output port such as USB, an Ethernet (registered trademark) port, and an antenna for wireless communication.

The display device 35 includes, for example, a liquid-crystal display panel.

A location detection device 36 uses a location measurement system, for example, a global locationing system (GPS) to detect a current location of the information processing apparatus 30. It should be noted that the location detection device 36 may be configured to detect the current location of the information processing apparatus 30 by another method instead of this location measurement system.

### Processing in Which First Information Processing Apparatus Displays Target Printer List Display Image

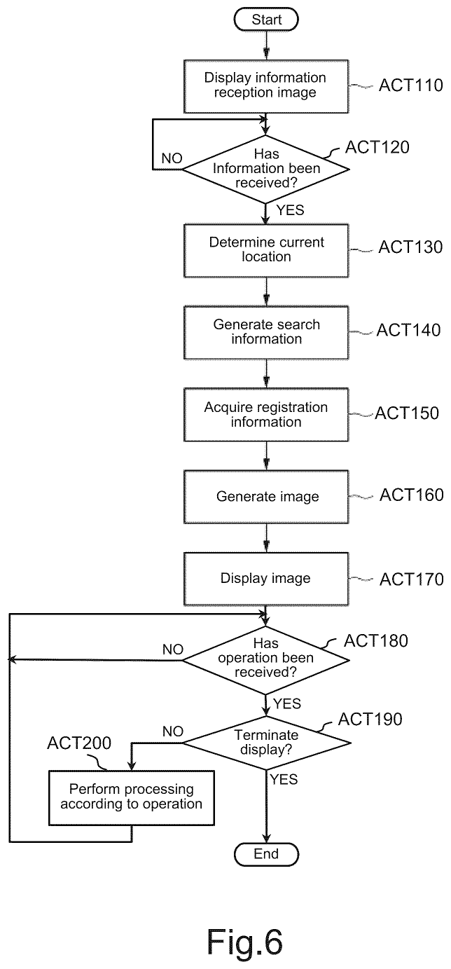

Processing in which the first information processing apparatus displays a target printer list display image will be described with reference to FIG. 6. FIG. 6 is a diagram showing an example of the processing in which the first information processing apparatus displays the target printer list display image. As an example, a case where the first information processing apparatus receives a processing start operation of causing the first information processing apparatus to start processing of displaying the target printer list display image before the processing of ACT 110 shown in FIG. 6 will be described. Therefore, each of the controller 31, the display device 35, and the location detection device 36 in the description of the flowchart shown in FIG. 6 may be the functional units provided in the first information processing apparatus.

After the controller 31 receives the processing start operation, the controller 31 generates an information reception image and causes the display device 35 to display the generated information reception image (ACT 110).

In ACT 110, the controller 31 waits for receiving each of the printing media type information and the search area information input by the input device 33 (e.g., the touch panel) via the information reception image displayed by the display device 35 (ACT 120). In FIG. 6, the processing of ACT 120 is shown as “Has information been received?”

In ACT 120, in a case where the controller 31 determines that the controller 31 has received each of the printing media type information and the search area information (YES in ACT 120), the controller 31 controls the location detection device 36 and determines a current location of the first information processing apparatus (ACT 130). The processing in ACT 130 may be performed in the order opposite to the order of the processing in ACT 120 to ACT 130 or may be performed in parallel with the processing in ACT 120 to ACT 130.

Next, the controller 31 generates search information including the printing media type information and the search area information received in ACT 120 and current location information indicating the current location determined in ACT 130 (ACT 140).

Next, in ACT 140, the controller 31 outputs to the server 10 the generated search information via the communication device 34. Accordingly, the controller 31 acquires one or more pieces of registration information as a response from the server 10 with respect to the search information output to the server 10 (ACT 150). Even in a case where no target printer is located within the search area, the controller 31 acquires one piece of registration information as null information, for example, from the server 10. Therefore, in ACT 150, the controller 31 acquires the one or more pieces of registration information.

Next, in ACT 150, the controller 31 generates a target printer list display image on the basis of the one or more pieces of registration information acquired (ACT 160). In FIG. 6, the processing in ACT 160 is shown as “Generate image.”

Next, in ACT 160, the controller 31 causes the display device 35 to display the generated target printer list display image (the image P shown in FIG. 3) (ACT 170). In FIG. 6, the processing in ACT 170 is shown as “Display image.”

Next, in ACT 170, the controller 31 waits for receiving an operation input by the input device 33 (e.g., the touch panel) via the target printer list display image displayed on the display device 35 (ACT 180). The operation received by the controller 31 via the target printer list display image is, for example, an operation of selecting printer information desired by the user, an operation of causing a map to be displayed via the button BA, or an operation of making an inquiry via the button BB, though not limited thereto.

In ACT 180, in a case where the controller 31 determines that the controller 31 has received the operation (YES in ACT 180), the controller 31 determines whether or not the received operation is an operation of causing the display device 35 to terminate the display of the target printer list display image (ACT 190). The operation of causing the display device 35 to terminate the display of the target printer list display image out of the operations received by the controller 31 via the target printer list display image may be any operation.

In a case where the controller 31 determines that the operation received in ACT 180 is not the operation of causing the display device 35 to terminate the display of the target printer list display image (NO in ACT 190), the controller 31 performs processing according to the operation received in ACT 180 (ACT 200). For example, in a case where the controller 31 has received the operation of selecting printer information desired by the user, the controller 31 selects printer information according to the received operation out of the printer information displayed on the target printer list display image. For example, in a case where the controller 31 receives the operation of causing the map to be displayed via the button BA, the controller 31 causes the display device 35 to display a map like the map MP shown in FIG. 4. For example, in a case where the controller 31 has received the operation of making an inquiry via the button BB, the controller 31 makes an inquiry to the information processing apparatus in the facility where the target printer indicated by the printer information selected by the user is placed. After the processing in ACT 200, the controller 31 shifts to ACT 180 and waits for receiving an operation via the target printer list display image displayed on the display device 35 again.

On the other hand, in ACT 180, in a case where the controller 31 determines that the received operation is the operation of causing the display device 35 to terminate the display of the target printer list display image (YES in ACT 190), the controller 31 causes the display device 35 to terminate the display of the target printer list display image. Then, the controller 31 terminates the processing of the flowchart shown in FIG. 6.

As described above, the information processing apparatus 30 receives the search information including the printing media type information indicating the target type and causes the display device 35 to display the printer information indicating each of the one or more target printers satisfying the selection condition on the basis of the received search information. Accordingly, the information processing apparatus 30 is capable of causing the user to search for the printer suitable to image printing desired by the user.

### Processing in Which Server that Has Acquired Search Information Outputs Registration Information

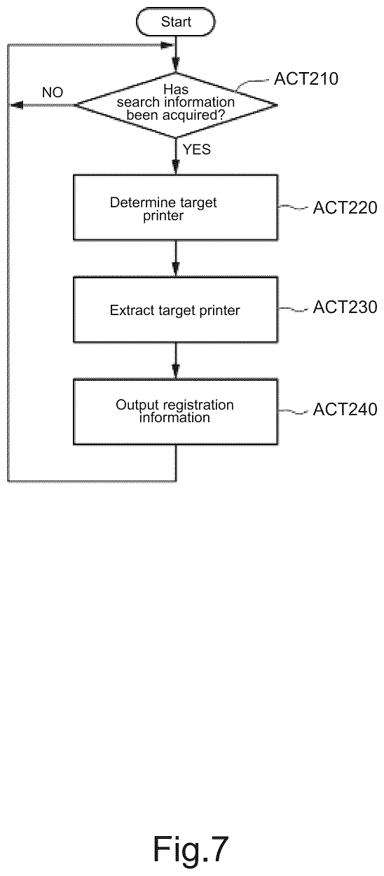

Processing in which the server 10 that has acquired search information outputs registration information will be described with reference to FIG. 7. FIG. 7 is a diagram showing an example of the processing in which the server 10 that has acquired the search information outputs the registration information. As an example, a case where the registration information regarding each of the N-number of printers 20 is stored in the server 10 before the processing in ACT 210 shown in FIG. 7 will be described.

The server 10 waits for acquiring the search information (ACT 210).

In ACT 210, in a case where the server 10 determines that the server 10 has acquired the search information (YES in ACT 210), the server 10 selects one or more target printers on the basis of printing media type information included in the acquired search information and the prestored registration information (ACT 220). In ACT 220, the processing of selecting the one or more target printers has already been described, and thus the duplicated description is omitted here.

Next, in ACT 220, the server 10 extracts a target printer located in the periphery of the information processing apparatus 30 that has output the search information from the one or more target printers selected (ACT 230). In ACT 230, the processing of extracting a target printer located in the periphery of this information processing apparatus 30 has already been described, and thus the duplicated description is omitted here.

Next, in ACT 230, the server 10 outputs the registration information of each of the one or more target printers extracted to the information processing apparatus 30 that has output the search information (ACT 240). After the processing in ACT 240, the server 10 shifts to ACT 210 and waits for acquiring search information again.

As described above, the server 10 outputs the one or more pieces of registration information to the information processing apparatus 30 that has output the search information on the basis of the acquired search information. Accordingly, the server 10 is capable of causing the user to search for the printer 20 suitable to image printing desired by the user via this information processing apparatus 30.

The information processing apparatus 30 may be configured to include some or all of the functions of the above-mentioned server 10.

The server 10 may be configured to include some of the functions of the above-mentioned information processing apparatus 30.

The above-mentioned server 10 may also serve as a content platform in which the user of the information processing apparatus 30 uses the printer 20 to store various images wished to be printed on a desired type of printing media. In this case, the user operates a desired printer 20 selected by the target printer list display image displayed on, for example, the information processing apparatus 30 to acquire a desired image from the server 10, and causes the printer 20 to print this image.

The above-mentioned information processing apparatus 30 may be configured to simultaneously display a target printer list display image like the image P (FIG. 3) and a map like the map MP (FIG. 4). In this case, the information processing apparatus 30 can improve the user's convenience because the information processing apparatus 30 facilitates the user's selection of a desired target printer.

The above-mentioned information processing apparatus 30 may be configured to include search area information indicating a predetermined radius in the search information. In this case, the information processing apparatus 30 receives no search area information. The above-mentioned server 10 may be configured to prestore the search area information. Also in this case, the information processing apparatus 30 receives no search area information.

The above-mentioned information processing apparatus 30 may be configured to include information indicating a region received in advance or a predetermined region in the search information instead of the configuration to include the current location information in the search information. In this case, the information processing apparatus 30 acquires from the server 10 registration information regarding each of target printers located within a region indicated by this information. In a case where the region indicated by this information is a predetermined region, the search information may be configured not to include this information.

Instead of the configuration to acquire the registration information from the server 10, the above-mentioned information processing apparatus 30 may be configured to directly communicate with the N-number of printers 20 and determine a target printer satisfying the selection condition from the N-number of printers 20. In this case, the information processing apparatus 30 acquires information corresponding to the registration information from the determined target printer and generates a target printer list display image.

The above-mentioned search information is information including at least the printing media type information in a case where the search information does not include the current location information and the search area information. In this case, the information processing apparatus 30 receives the printing media type information and causes the display device 35 to display the printer information indicating each of the one or more target printers satisfying the selection condition on the basis of the received printing media type information.

In a case where the above-mentioned information processing apparatus 30 receives an operation via the button BB, the information processing apparatus 30 may be configured to cause a telephone number of a facility where a target printer indicated by selected printer information is placed to be displayed instead of a configuration to make such an inquiry. In this case, the user can make an inquiry by him- or herself through a call using the telephone number.

The above-mentioned matters may be freely combined.

A program for realizing the functions of any constituent blocks in the above-mentioned apparatus (e.g., the server 10, the printer 20, the information processing apparatus 30) may be recorded on a computer-readable recording medium and the program may be loaded and executed in a computer system. The term set forth herein “computer system” includes an operating system (OS) and hardware such as peripheral equipment. The “computer-readable recording medium” refers to a storage device including portable media such as a flexible disk, a magneto-optical disk, an ROM, and a compact diss (CD)-ROM, a hard disk built in the computer system, and the like. The “computer-readable recording medium” also includes one retaining a program for a certain time like a volatile memory (RAM) inside a computer system which is a server or client in a case where the program is sent via a network such as the Internet or a communication line such as a telephone line.

The above-mentioned program may be transmitted from the computer system that has stored this program in the storage device or the like to another computer system via a transmission medium or by transmission waves in the transmission medium. The “transmission medium” that transmits the program refers to a medium that functions to transmit information like a network (communication network) such as the Internet or a communication line such as a telephone line. The above-mentioned program may be one for realizing some of the above-mentioned functions. The above-mentioned program may be one capable of realizing the above-mentioned functions in combination with a program that has been recorded in the computer system, a so-called difference file (difference program).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus that is capable of selecting a printer suitable to printing an image from a plurality of printers connected to a network, comprising:
an input device that inputs printing media type information indicating a type of printing media on which images are to be printed;
a display device that displays printer information indicating a printer; and
a processor configured to
generate search information at least including the printing media type information input by the input device,
acquire, on a basis of registration information including the printer information indicating each of the plurality of printers prestored and the generated search information, registration information including printer information indicating each of one or more printers satisfying a condition related to the type of printing media, and
cause the display device to display printer information included in the acquired registration information.

2. The information processing apparatus according to claim 1, further comprising
a communication device that communicates with a server apparatus that prestores registration information including printer information indicating each of the plurality of printers.

3. The information processing apparatus according to claim 2, wherein
the processor sends the generated search information to the server apparatus via the communication device.

4. The information processing apparatus according to claim 3, wherein
one or more printers satisfying the condition related to the type of printing media are selected by the server apparatus on a basis of registration information including printer information indicating each of the plurality of printers and the generated search information.

5. The information processing apparatus according to claim 3, wherein
registration information including printer information indicating one or more printers satisfying the condition related to the type of printing media is selected by the server apparatus from registration information including printer information indicating each of the plurality of printers on a basis of the generated search information.

6. The information processing apparatus according to claim 3, wherein
the processor acquires registration information including printer information indicating one or more printers satisfying the condition related to the type of printing media from the server apparatus via the communication device as a response to the sent search information.

7. The information processing apparatus according to claim 1, wherein
the condition related to the type of printing media includes a printer to which a printing medium indicated by the input printing media type information is set.

8. The information processing apparatus according to claim 1, wherein
the condition related to the printing media type includes that the printing medium indicated by the input printing media type information is stored as printing media which can be set to the printer.

9. The information processing apparatus according to claim 1, wherein
the input device receives an operation of selecting the printer displayed on the display device, and
the controller causes the display device to display a map indicating a location of each of the one or more printers selected in accordance with an operation received by the input device.

10. An information processing method for an information processing apparatus that is capable of selecting a printer suitable to printing an image from a plurality of printers connected to a network, comprising:
inputting, by an input device, printing media type information indicating a type of printing media on which images are to be printed;
generating search information at least including the printing media type information input by the input device;
acquiring, on a basis of registration information including the printer information indicating each of the plurality of printers prestored and the generated search information, registration information including printer information indicating each of one or more printers satisfying a condition related to the type of printing media; and
causing the display device to display printer information included in the acquired registration information.
